(19) United States
(12) Patent Application Publication
(10) Pub. No.: US 2008/0210480 A1
(43) Pub. Date: Sep. 4, 2008

(54) Drive Train, Pertaining Operating Method and Motor Vehicle

(75) Inventor: Dieter KRAXNER, Wurmberg (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 12/038,420

(22) Filed: Feb. 27, 2008

(30) Foreign Application Priority Data
Mar. 1, 2007 (DE) 10 2007 010 027.4

(51) Int. Cl. B60K 6/20

(52) U.S. Cl. 180/65.2; 903/902

(57) ABSTRACT

Method is disclosed for operating a drive train having an electric machine and an internal-combustion engine with a supercharger having at least one additional electric machine for the optional drive of a power transmission. An optimal operating point of the at least one additional electric machine is selected as a function of the definable operating point of the internal-combustion engine such that the electric energy flowing during the operation of the at least one additional electric machine at the optimal operating point flows between electric machines without any detouring.

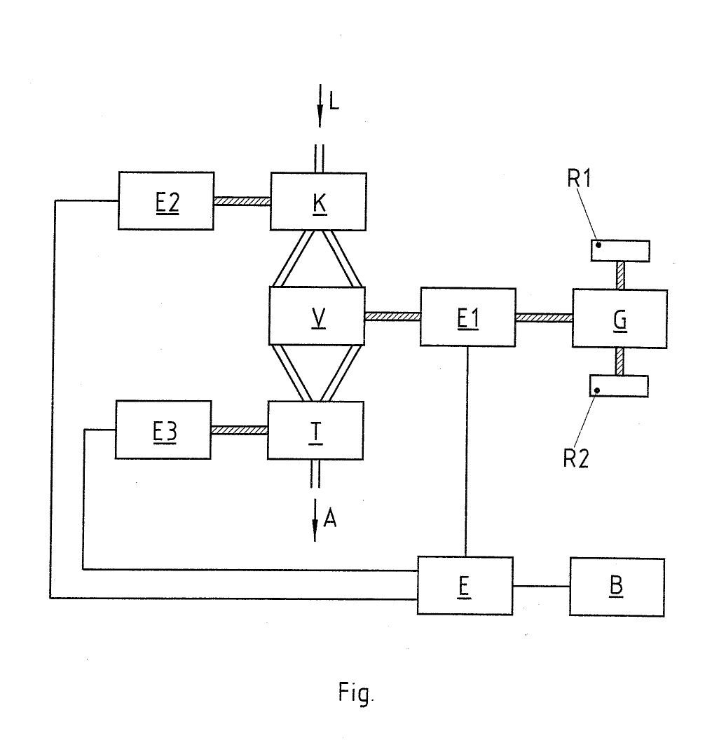

### BACKGROUND AND SUMMARY OF THE INVENTION

This application claims the priority of German Patent Application No. 10 2007 010 027.4-51, filed Mar. 1, 2007, the disclosure of which is expressly incorporated by reference herein.

The present invention relates to a drive train, particularly for a motor vehicle, having an electric machine, particularly a motor-generator unit, and an internal-combustion engine for optional connection with a power train, such as a transmission, as well as to a method of operating such a drive train and to a motor vehicle having such a drive train.

A drive train of the aforementioned type is used particularly in the case of modern motor vehicles with a hybrid drive. When such a drive train is further developed so that an internal-combustion engine and an electric motor are not only alternatively but also cumulatively connected with the power train and drive the latter, i.e., can initiate torque, this is also called a parallel hybrid drive. Such hybrid drives are distinguished by reduced fuel consumption as well as reduced pollutant emissions.

Superchargers are additionally used for increasing the power in the case of conventional internal-combustion engines. By enlarging the charge quantity, an efficiency improvement is achieved in that more air, and therefore also more oxygen, is guided into the combustion chambers of the cylinders. The result is a power increase without requiring a displacement increase in the internal-combustion engine. In addition, the supercharger can be used for lowering the fuel consumption and thus the exhaust gas emissions of the internal-combustion engine. For example, a compressor driven by the engine by ways of a toothed belt or a turbocharger driven by the exhaust gas flow of the internal-combustion engine can be used as the turbocharger. The problem arises here, however, that the operating point of the supercharger is usually dependent on the operating point of the internal-combustion engine. For example, in the case of the turbocharger, as a result of the rigid coupling of the turbine with the compressor, complicated measures, such as variable turbine geometry, are required for controlling the operation.

An object of the present invention is to improve such a drive train as well as a related operating method, and particularly to increase the efficiency.

The object has been achieved based on the recognition that electric energy in the case of a hybrid drive can flow virtually constantly because of the at least one electric machine comprised by the drive train. Thus, for example, in a parallel hybrid drive with the motor-generator unit, an electric machine is provided which can be operated optionally as a motor or generator, for the alternative and cumulative drive of the power train. As a result, it is virtually constantly possible to either retrieve electric energy (for example, in the case of the parallel hybrid drive when the motor-generator unit is operated as a generator) and/or to feed energy (for example, in the case of the parallel hybrid drive when the motor-generator unit is operated as a motor). This electric energy is best used directly, that is, without a dissipative detour by way of energy accumulators, such as a battery.

Normally, however, an energy accumulator, usually a battery, is provided in the case of a hybrid drive, for storing obtained electric energy (for example, from a regenerative braking) and for its later retrieval (for example, for an electric boosting). Considerable conversion losses arise, however, because of the interposition of the battery and the resulting charging and discharging operations.

The present invention provides a remedy here in that the electric energy flows without detours between electric machines, such as the electric machine for the optional operating of the power train and at least one additional electric machine of the supercharger of the internal-combustion engine. This approach eliminates the conversion losses occurring when using energy accumulators and can be used, not only in the case of the parallel hybrid drive but, also in the case of other constructions, such as the power-branching hybrid drive, where additional electric machines are present.

Correspondingly, with the approach according to the invention, an always optimal operating point of the electric machine or of each additional electric machine of the supercharger of the internal-combustion engine is obtained. Since the electric energy always flows without any detour or rerouting between electric machines, only as much electric energy is always requested by one (or several) electric machines as can be supplied by one (or several) electric machines. This is ensured, for example, by an electronic power system or by a corresponding control device for monitoring the flux of the electric energy. More detailed information will be supplied in this respect by ways of the following.

In a contemplated advantageous embodiment of the invention, the additional electric machine is provided as the electric motor, particularly for the operation of a compressor or of the compressor side of a turbocharger of the internal-combustion engine. This electric motor will then be supplied without detour or rerouting with electric energy by the electric machine of the hybrid drive train, for example when a motor-generator unit is operated as a generator. In this case, however, only as much energy needs to be retrieved from the generator, i.e., only as much mechanical resistance has to be overcome by the latter, as is required for just operating the electric motor at the optimal operating point. Then, the optimal operating point of the electric motor is a function of the momentary operating point of the internal-combustion engine, i.e., of the just required air quantity. The compressor or the compressor side of the turbocharger is therefore always capable of providing the just required air quantity, irrespective of the momentary power of the internal-combustion engine or of the energy content of the exhaust gas flow. As a result of supplying the electric motor of the supercharger with electric energy without any detour, lower conversion costs occur then with the detour by way of an intermediate storage device, such as a battery.

In another contemplated advantageous embodiment, the additional electric machine is provided as the generator, particularly driven by the turbocharger turbine or by a turbine in the exhaust gas flow. As a result, the maximally conceivable or momentarily required energy quantity can always be obtained from the exhaust gas flow, i.e., only as much energy needs to be left there as is momentarily still necessary for the proper operation. This retrieved energy quantity is then converted by the generator to electric energy, whereby the generator is always operated at the optimal operating point. The electric energy supplied by the generator can be guided without detour or rerouting to the electric machine of the hybrid drive train, for example, the motor-generator operated as a motor, and can thereby correspondingly relieve the internal-combustion engine.

A regulating intervention at the internal-combustion engine may also be provided for a corresponding power reduction in the foregoing case. As an alternative, a limitation to the momentarily required energy quantity can also be carried out by a lowering of the generator load, i.e., of the mechanical resistance to be overcome. As a result of the supply of electric energy without detouring, the occurring conversion losses are also lower than in the case of a detour by way of an intermediate storage device, such as a battery.

In a currently particularly preferred embodiment of the invention, two additional electric machines are provided, specifically an electric motor, particularly for the operation of a compressor or of the compressor side of a turbocharger of the internal-combustion engine, and a generator, particularly driven by the turbine of a turbocharger or by a turbine in the exhaust gas flow. The supercharger can thereby always be operated at the optimal operating point of the two additional electric machines. As a function of the momentary operating point of the internal-combustion engine, at the optimal operating point of the electric motor, the just required air quantity is always provided to the internal-combustion engine. At the optimal operating point of the generator, the maximally conceivable or a momentarily required energy quantity is always obtained from the exhaust gas flow and converted to electric energy.

In the aforementioned embodiment, the electric motor and the generator can be controlled independently of one another, whereby optimal operating points of both electric machines or of the compressor and of the turbine are made possible in any situation. In this event, the energy supply of the electric motor is provided without detour from the generator. When, on one hand, the generator driven by the turbine supplies, for example, too little energy, the energy lacking can be obtained without any detour from the electric machine of the hybrid drive train, e.g., the motor-generator unit operated as a generator. When, on the other hand, the generator supplies too much electric energy, the latter can flow without any detour to the electric machine of the hybrid drive train, for example, the motor-generator unit operated as a motor and thus correspondingly can relieve the internal-combustion engine. In this case, a regulating intervention at the internal-combustion may also be provided for a corresponding power reduction.

As an alternative to the foregoing, a limitation to the momentarily required energy quantity can be carried out by a lowering of the generator load, i.e., of the mechanical resistance to be overcome. As a result of the supply of electric energy without any detour, the conversion losses occurring will also be lower than in the case of a detour by way of an intermediate storage device, such as a battery. An optimal power of the supercharger, i.e., an operation at optimal operating points, can therefore always be achieved.

It is advantageously suggested to provide an electric energy accumulator, particularly for making available electric energy which, for a short period of time, cannot be supplied without detour by a generator or for receiving electric energy which, for a short period of time, is not required by an electric motor. In this case, however conversion losses should also be taken into account. It therefore may, be more practical to provide, for example, a change in the triggering of the respective electric machine. By way of one such example, a limitation to the momentarily required energy quantity can be carried out by a lowering of the generator load, i.e., of the mechanical resistance to be overcome. Because the electric energy accumulator is only provided here in a supporting manner, it may have a smaller construction which results in a saving of weight and expense.

Furthermore, a regulating intervention at the internal-combustion engine may be provided for ensuring an optimal operating point of the respective electric machines. For example, a power reduction of the internal-combustion engine during the electrical boosting by the motor-generator unit may be provided when excessive electric energy of the generator of the turbine is available. By the optimal adjustment of all components of the hybrid drive train, an optimally efficient operation of the entire drive train can therefore be achieved at any point in time. Additionally, in the case of the charging system, a bypass can be provided at the compressor side and/or turbine side for further increasing the efficiency.

A particularly good utilization of energy is obtained when the electric machines are provided as electric synchronous machines, that is, rotary current motors. Additional advantages in this case are the bypassing of possible converters/rectifiers and lower losses by higher alternating voltages. The electric energy can correspondingly flow between the electric machines with particularly low losses.

It is understood that the above-mentioned characteristics and the characteristics to be explained in the following can be used not only in the respectively indicated combination but also in other combinations or alone without leaving the scope of the present invention.

Other objects, advantages and novel features of the present invention will become apparent from the following detailed description of the invention when considered in conjunction with the accompanying drawings.

### BRIEF DESCRIPTION OF THE DRAWING

The sole FIGURE is a simplified schematic diagram of a drive train according to the invention.

### DETAILED DESCRIPTION OF THE DRAWING

A drive train comprises an internal-combustion engine V, and electric machine E1 as well as a power transmission G which preferably can be further developed as an automatic transmission. Components V, E1 and G are mutually mechanically coupled by corresponding shafts. The power transmission G transmits a corresponding torque to the wheels R1, R2 of the motor vehicle in which the drive train is provided.

A supercharger for compressing ambient air L is assigned to the internal-combustion engine V. The supercharger comprises a compressor K driven by an electric machine E2, for feeding compressed air to the internal-combustion engine V. Furthermore, the supercharger comprises a turbine T for driving an electric machine E3 by the exhaust gas flow A originating from the internal-combustion engine V.

Furthermore, an electronic power system or a control device E is provided for controlling the supplying of the electric machines E1, E2 and E3 with electric energy. In this case, the electronic power system E has access to an energy accumulator B for retrieving or storing energy peaks.

The electronic power system E carries out control of the electric machines E1, E2 and E3 such that, if possible, these machines are each operated at an optimal operating point, and electric energy flows without detouring, i.e., without a falling-back on or rerouting to the energy accumulator B between the electric machines. The electric machine E1 is provided as a motor-generator unit which can optionally be operated either as a motor or as a generator. The electric machine E2 is operated as a motor for driving the compressor K. In this case, the electronic power system E, for example, by using a corresponding sensor or characteristic diagram data, provides an always optimal operating point of the compressor K and thereby the triggering of the electric machine E2. This takes place in that in each case the momentarily optimally needed air quantity L is fed to the internal-combustion engine V, and the optimal operating point of the electric machine E2 is thereby coordinated.

The electric machine E3 is operated as a generator driven by the turbine T in the exhaust gas flow A of the internal-combustion engine V. For this purpose, the electric machine E3 is coupled with the turbine T. The mechanical resistance of the turbine T in the exhaust gas flow can be regulated by way of the generator load of the electric machine E3. This results in an always optimal utilization of the energy of the exhaust gas flow A regulated by the electronic power system E. The electric energy required for driving the electric machine E2 is guided without any detour from the electric machine E3, controlled by the electronic power system E, to the electric machine E2.

By way of the electronic power system E, it is therefore ensured that the maximally possible or the just required energy can always be retrieved from the exhaust gas flow A and the electric machine E3 can therefore always be operated at the optimal operating point. Furthermore, the control via the electronic power system E ensures that the electric machine E2 always provides an optimal operating point for operating the compressors K. In this case, the required electric energy flows without detours from E3 by way E to E2, i.e., without using a dissipative via the energy accumulator B.

Furthermore, the electronic power system E has access to the electric machine E1 which can be mechanically coupled with the internal-combustion engine V. The electronic power system E also ensures control of the electric machine E1. For example, additionally required electric energy that is needed by electric machine E2 but momentarily cannot be provided by electric machine E3 can be retrieved from electric machine E1. Thus, the electric machine E2 can always be supplied with electric energy with assurance without dissipative detours by way of the energy accumulator B by at least one electric machine operated as a generator.

Additional electric energy supplied by the electric machine E1, which momentarily is not needed by the electric machine E2, can, for example, be stored in the energy accumulator B. Otherwise, the electric machine E1 can be triggered by the electronic power system E such that it also does not supply this momentarily not needed energy quantity.

In special operating situations, for example, when the electric machine E1 is operated as a motor and the electric machine E3 does not supply sufficient electric energy for supplying the electric machine E2 at the optimal operating point, the electric energy needed by the electric machine E2 can be retrieved from the energy accumulator B. Otherwise, the electric machine E2 can be correspondingly regulated by the electronic power system E. In the event that the electric machine E3 supplies more electric energy than momentarily needed by the electric machine E2, that excess energy can be used for operating the electric machine E1 as a motor, i.e., for electric boosting. As an alternative or in addition, the electric energy can also be stored in the energy accumulator B.

Summarizing, the present invention permits a clear efficiency increase of a hybrid drive train having an internal-combustion engine having a supercharger. Because the electric machines of the supercharger are therewith always operated at the optimal operating point, a best-possible functioning of the supercharger of the internal-combustion engine is ensured. The electronic machines are, controlled by the electronic power system and are supplied with electric energy essentially without any dissipative detour by way of an energy accumulator. Thereby energy losses of the drive train can be minimized.

The present invention also provides that only the electric machine E2 or, as an alternative, only the electric machine E3 can be present. In this case too, there is still a clear efficiency increase of the overall drive train.

Furthermore, as a result of the concept according to the invention, even novel valve trains are contemplated such as, for example, elimination of the throttle valve. For this purpose, the charge quantity of the combustion chambers of the cylinder of the internal-combustion engine V is controlled by the compressor K driven by the electric machine E2. For the throttling, it may be necessary to brake the compressor K by the electric machine E2 operated as a generator and thereby return energy by way of the electric machine E1 into the hybrid drive train or, as an alternative or in addition, into the energy accumulator B.

Furthermore, the present invention provides greater flexibility in that, for example, the electric machine E3 is used as a motor in special situations for ensuring a low drive of the turbine T to reduce a corresponding mechanical flow resistance in the exhaust gas flow A. By way of influencing the exhaust back pressure, the charge cycle operations in the internal-combustion engine V can also be positively influenced. Moreover, when reducing the kinematic energy of the exhaust gas flow via the turbine T at the generator, a positive effect can be achieved for muffler noise reduction so that the volume and the weight of the exhaust system can be reduced. For optimizing or simplifying the controlling of the drive train control, bypasses can additionally be provided in the case of the compressor K and/or in the case of the turbine T.

In addition, for eliminating an energization of the electric machines in an idling operation, respective clutches can be advantageously provided for uncoupling the electric machine E2 from the compressor K or the electric machine E3 from the turbine T. As an alternative or in addition, clutches or converters may be provided between the electric machine E1 and the internal-combustion engine V or the electric machine E1 and the power transmission G respectively.

Of course, it should be clearly understood that the concept according to the present invention can be used not only in a motor vehicle but, for example, also in ships, rail vehicles and other driven objects.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Drive train, comprising an electric machine and an internal-combustion engine having a supercharger with at least one additional electric machine, for optional connection with a power transmission, and a control device configured so as to adjust, as a function of an operating point of the internal combustion engine, a respective optimal operating point of the at least one additional electric machine whereby the electric energy flowing during operation of the at least one additional electric machine at the optimal operating point flows between or among all the electric machines without any detouring.

2. Drive train according to claim 1, wherein the first-mentioned electric machine is a motor-generator unit for alternative and cumulative power transmission drive.

3. Drive train according to claim 1, wherein one of the at least one additional electric machine of the supercharger is an electric motor for operation of a compressor or of a compressor side of an internal-combustion engine turbocharger.

4. Drive train according to claim 3, wherein one of the at least one additional electric machine of the supercharger is an electric motor for operation of a compressor or of a compressor side of an internal-combustion engine turbocharger.

5. Drive train according to claim 3, wherein another of the at least one additional electric machine of the supercharger of the internal-combustion engine is a generator, driven by an exhaust gas flow turbine or by a turbocharger turbine.

6. Drive train according to claim 1, wherein the internal-combustion engine has no throttle valve and has at least one electric machine for regulating the air quantity to be fed thereto.

7. Drive train according to claim 1, wherein the electric machines are electric synchronous machines.

8. Drive train according to claim 1, wherein at least one bypass is provided in the case of the supercharger.

9. Motor vehicle having a drive comprising an electric machine and an internal-combustion engine having a supercharger with at least one additional electric machine for optional connection with a power transmission, and a control device configured so as to adjust, as a function of an operating point of the internal-combustion engine, a respective optimal operating point of the at least one additional electric machine whereby the electric energy flowing during operation of the at least additional electric machine at the optimal operating point flows between or among all the electric machines without any detouring.

10. Method for operating a drive train having drive train has an electric machine and an internal-combustion engine with a supercharger having at least one additional electric machine for the optional drive of a power transmission, comprising selecting, an optimal operating point of the at least one additional electric machine as a function of a definable operating point of the internal-combustion engine, such that the electric energy flowing during the operation of the at least one additional electric machine at the optimal operating point flows between electric machine (without any detouring.

11. Method according to claim 10, further comprising providing a control intervention at the internal-combustion engine to ensure an optimal operating point of the electric machines.
